(19) United States
(12) Patent Application Publication
(10) Pub. No.: US 2022/0164231 A1
(43) Pub. Date: May 26, 2022

(54) DETERMINE SPECIFIC DEVICES FROM FOLLOW-UP QUESTIONS

(71) Applicant: Hewlett-Packard Development Company, L.P., Spring, TX (US)

(72) Inventors: Vinicius da Silva, Porto Alegre (BR); Cassio Ruggeri Cons, Porto Alegre (BR); Vinicius Hisao Suzuki, Porto Alegre (BR); Rodrigo Guthler Ramos, Porto Alegre (BR)

(73) Assignee: Hewlett-Packard Development Company, L.P., Spring, TX (US)

(21) Appl. No.: 17/602,869

(22) PCT Filed: Jul. 29, 2019
(86) PCT No.: PCT/US2019/043901

§ 371 Date: Oct. 11, 2021

(51) Int. Cl. G06F 9/50

(52) U.S. Cl. CPC G06F 9/5016

(57) ABSTRACT

In some examples, a system can include a processing resource and a memory resource storing machine readable instructions to cause the processing resource to receive a description of a plurality of features of a specific device, identify distinguishable features for a plurality of different devices based on the description of the plurality of features, provide a plurality of follow-up questions based on the distinguishable features of the plurality of different devices, and determine a unique identifier for the specific device from the plurality of different devices based on the description and information received in response to the plurality of follow-up questions.

### BACKGROUND

Products (e.g., devices, retail items, etc.) can be chosen from an inventory of products. A product can be looked up from a product inventory by using a unique identifier associated with the product (e.g. model number, names, other technical aspects, etc.).

### BRIEF DESCRIPTION OF THE DRAWINGS

FIG. 1 is an example of a system to determine specific devices from follow-up questions consistent with the disclosure.

FIG. 2 is an example of a computing device to determine specific devices from follow-up questions consistent with the disclosure.

FIG. 3 is an example memory resource to determine specific devices from follow-up questions consistent with the disclosure.

FIG. 4 is a flow diagram of user interaction to determine specific devices from follow-up questions consistent with the disclosure.

### DETAILED DESCRIPTION

A product inventory may be received from sources such as an internal product database, external product database, Internet, etc. Particular products can be looked up from the product inventory by using a unique identifier associated with the product. For example, a user may look up a printer from a database of printers by using a model number, make, serial number, and/or name of the printer.

In some examples, a user may enter information about a particular product and receive a subset of products that match the information stored in the product inventory. The subset of products may be created by narrowing down a relatively large group of products into a smaller group of products. The user may select the product from a smaller group based on the user's expertise. For example, a user may enter a model number for a printer and receive a narrow list of printers that associate with the model number entered. From the narrow list of printers, the user can identify and select a particular printer. However, such systems are limited to narrowing down a list by a unique reference and relying on human-expertise to pick a desired product. Thus, these previous systems can be time consuming and non-user friendly.

In some examples, products may be identified based on a search term query analyzed via a machine learning model. As used herein, the term “machine learning” refers to a computing device or system that utilizes a model based on sample data in order to make predictions or decisions without specifically being programed to make the predictions or decisions. In some examples, the machine learning model can identify how closely various attributes of two products match based on patterns between the two products. However, such systems are limited to using information archived in the database during an initial time period and are not updated dynamically.

Accordingly, the disclosure is directed towards determining specific devices from follow-up questions based on an initial description of a specific device. As used herein, the term “specific device” refers to an object, machine, and/or piece of equipment that includes a unique identifier to distinguish the specific device from other devices. As described herein, the term “description” refers to a descriptive representation of an item, product, and/or a device. For example, a description can include written statements, images, voice commands, gestures, etc. In some examples, the system can provide follow-up questions to the description based on identified distinguishable features between a plurality of devices that are related to the description. In some examples, different device can be devices with features different than the features of the specific device. In some examples, based on the response received from the follow-up question, a narrower list can be generated from which a unique identifier for the specific device can be identified. As described herein, the term “feature” refers to a structure, form, or appearance of a device. As described herein, the term “distinguishable feature” refers to distinctive attribute and/or aspect of the feature that makes devices distinct from each other. For example, a system can identify a plurality of features that match a description of a printing device and identify a distinguishable feature to be a specific color of the printing device that distinguishes some of the printing devices from other printing devices. As described herein, the term “unique identifier” refers to a numeric, alphanumeric string and/or a combination of both that is associated with a single device/item.

In some examples, the system can provide a list of devices that the system and/or a user can utilize to select the specific device from the list of devices. For example, the system can generate the list of the devices based on the description and the response to follow-up questions. In this example, the list of devices can each include features that were described in the original description and/or the response to the follow-up question. In some examples, if there is a discrepancy between a previously stored description and a newly received description the system can be updated to include the newly received description. This can provide narrower results for ambiguous searches and improve user experience by providing more probable list of devices.

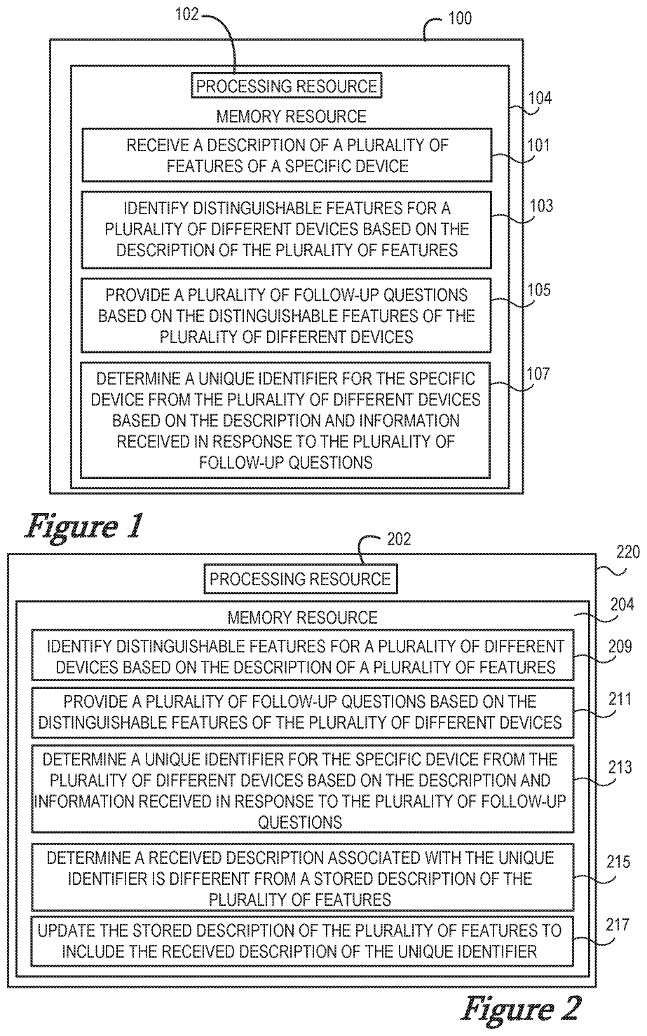

FIG. 1 is an example of a system 100 to determine specific devices from follow-up questions consistent with the disclosure. The system 100 can include a processing resource 102 communicatively coupled to a memory resource 104 storing instructions 101, 103, 105, and 107 to perform particular functions associated with determining specific devices from follow-up questions.

Although the following descriptions refer to a single processor and a single memory resources, the descriptions can also apply to a system with multiple processing resources and memory resources. In such examples, the system 100 can be distributed across multiple memory resources with machine-readable storage mediums and the system 100 can be distributed across multiple processing resources. Put another way, the instructions executed by the system 100 can be stored across multiple machine-readable storage mediums and executed across multiple processors, such as in a distributed or virtual computing environment.

Processing resource 102 can be a central processing unit (CPU), a semiconductor based microprocessor, and/or other hardware devices suitable for retrieval and execution of machine-readable instructions 101, 103, 105, 107, stored in memory resource 104. Processing resource 102 can fetch, decode, and execute instructions 101, 103, 105, and 107. As an alternative or in addition to retrieving and executing instructions 101, 103, 105, and 107, the processing resource 102 can include a plurality of electronic circuits that include electronic components for performing the functionality of instructions 101, 103, 105, and 107.

Memory resource 104 can be any electronic, magnetic, optical, or other physical storage device that stores executable instructions 101, 103, 105, and 107 and/or data. Thus, memory resource 104 can be, for example, Random Access Memory (RAM), an Electrically-Erasable Programmable Read-Only Memory (EEPROM), a storage drive, an optical disc, and the like. Memory resource 104 can be disposed within the system 100 as shown in FIG. 1. Additionally, and/or alternatively, memory resource 104 can be a portable, external or remote. As described herein, machine-readable storage medium 104 may be encoded with executable instructions for determining specific devices from follow-up questions.

Instructions 101, when executed by a processing resource such as processing resource 102, can cause system 100 to receive a description of a plurality of features of a specific device. For example, system 100 can receive a description of a plurality of features (e.g., compact, prints photos, portable, etc.) of a specific device. In some examples, the description of the plurality of features can be received via an audio recording device (microphone, etc.). In some examples, the description of the plurality of features can be received by a textual representation (e.g., digital text, etc.). In some examples, the description of the plurality of features can be received via speech and converted to text. In some examples, the description of the plurality of features can be received from a physical gesture received from a user.

In some examples, the description of the plurality of features of the specific device can include a device type of the specific device. For example, the description of the plurality of features can include “printing device using ink to print images”. Based on the description of the plurality of features, the system 100 can determine that the specific device being described is an inkjet printing device.

In some examples, the description of the plurality of features of the specific device can include a geographic location of the specific device. For example, a user can include the geographic location of a printing device (e.g., Minneapolis, Minn., etc.) to describe the printing device. In some examples, the user can utilize a physical location of feature to describe the specific device. For example, a user can describe a color of the specific device at a first location on the specific device. In some examples, the system 100 can determine a list of devices that include the color described at the first location. In some examples, the location of the features on the specific device can be used to distinguish between the specific device and other devices. For example, a plurality of devices can include a particular feature such as a particular color. However, the specific device can include the particular feature at a specific location, which may not be included on the other devices. In some examples, the particular feature at the specific location can be a distinguishing feature when the particular feature at the specific location distinguishes the specific device from the different devices. For example, a first type of device may include a particular color at a first location and a second type of device may include the particular color at a second location. In this example, the particular color at the first location can be utilized to distinguish the first type of device from the second type of device.

In some examples, a machine learning model can be used to cluster the described features to detect similarities among features. In some examples, convolutional neural network (CNN) model of deep learning, as further described herein, can be used to analyze the received description, to identify the features described, and update the system to include any new feature associated with the specific device. In some examples, artificial neural networks (ANN) model, as further described herein, can be used to analyze description of the features of a specific device, and update the system to include any new feature associated with the specific device. In some examples, the ANN model can use image recognition method to identify images of the different devices by analyzing example images that have been tagged. For example, an ANN model can use a device tagged as “portable printing device” and/or a device tagged as “non-portable printing device” to identify portable printing devices from images of printing devices. In some examples, the ANN model can do this without any prior knowledge about portable printing devices. For example, the ANN model can identify devices as portable printing device that have the capability to print, are portable, and/or small in sizes. The ANN model can automatically generate identifying characteristics from the learning material, for example, description received about the plurality of features, that they process.

Instructions 103, when executed by a processing resource, such as processing resource 102, can cause system 100 to identify distinguishable features for a plurality of different devices based on the description of the plurality of features. In some examples, the plurality of different devices can include the specific device and other devices with the plurality of features. For example, a description can include “a white slim device with print, copy, and scan capability, blue logo on center top of the top surface, two way network connection, and portable”. Based on the description, the system 100 can identify a first printing device that is wireless, white, and portable printing device. In addition, the system 100 can also identify other devices that include the plurality of features that overlaps with features of the specific device. For example, the system 100 can identify a second printing device that is white and has a blue logo on center top of the surface, and with print, copy, and scan capability. In some examples, the system 100 can identify distinctive features between the first printing device and the second printing device that makes them different from each other and/or other printing devices by identifying specific features that are not shared between the first printing device and the second printing device.

In some examples, the instructions to receive the description of the plurality of features of the specific device can include identifying physical features of the specific device that are different than physical features of the other devices. For example, the computing device 220 can identify that the plurality of features for the specific device and the other devices are distinct based on a description of physical features of the different devices. For example, physical features of the received description of the specific device can include metallic grey case with black logo, and 15-inch screen. Contrarily, physical features of the other devices can include a black case with metallic silver grey logo and 21-inch screen. Based on that determination, computing device 220 can identify a first distinctive feature as the case color (e.g., black vs grey, etc.), a second distinctive feature as a logo color (e.g., black vs silver grey, etc.), and/or a third distinctive feature as a screen size (e.g., 15-inch vs 21-inch, etc.).

In some examples, a conceptual type association is utilized to identifying a category of devices based on the description of the plurality of features of the specific device can include detecting a conceptual type association. In some examples, the conceptual type association can identify a generic device even when a specific device is described. In some examples, the conceptual type association is made by connecting the description of the plurality of features of the specific device to a plurality of related concepts. In some examples, the conceptual association can be opposite of literal association. For example, when a user describes a specific tablet device (e.g., TouchPad) a computer logic can associate the concept of a tablet computer rather than the specific tablet device (e.g., HP TouchPad).

In some examples, the system 100 can include instructions to tag each feature of the plurality of features with a reference tag. As used herein, a reference tag can include an indicator with information associated with a tagged feature. In some examples, the plurality of devices can include stored information with tags that include additional information for each of the plurality of features of the plurality of devices. In some examples, features that were described by a user can be compared to the tagged features of the plurality of devices to determine if the described features are the same or similar to the tagged features.

In some examples, the system 100 can include instructions to detect associations between a distinguishable feature of the specific device and the reference tag, For example, a plurality of features of a specific device can be tagged with a reference tag. In some examples, the reference tag can include words, images, and/or other identifying marks assigned to a feature of the specific device. The system 100 can identify the features to be same when the reference tag associates with the feature of the specific device and groups them together. In some examples, information received from the distinguishable features can be used to dynamically update system 100 and improve grouping accuracy of the plurality of features from a corresponding description.

Identifying the distinguishing features can help narrow the list of different devices and help determine the follow-up questions. For example, the system 100 can receive a description of the specific device and the system can identify a plurality of devices that share similarities to the description. In this example, the system 100 can determine distinguishable features between the plurality of identified devices and generate a follow-up question that is based on the distinguishable features.

Instructions 105, when executed by a processing resource, such as processing resource 102, can cause system 100 to provide a plurality of follow-up questions based on the distinguishable features of the plurality of different devices. In some examples, a plurality of follow-up questions can be provided when features of the plurality of devices are identified as distinguishable from each other. For example, if a first feature of a first device is identified to be different from a second feature of a second device, the system can generate follow-up questions directed to determine if the specific device is the first device or the second device based on a response to the follow-up questions. In some examples, the follow-up questions can help receive additional information and further narrow the list of identified devices that share the original description of the specific device. For example, the system 100 can determine that a first distinguishable feature between the plurality of identified devices is color. In this example, the system 100 can ask a follow-up question about the color of the specific device. In response to the follow-up question, the system 100 can narrow the list of the plurality of identified devices and identify a distinguishable feature between the narrowed list of the plurality of identified devices. Again, the system 100 can ask a follow-up question based on the identified distinguishing feature between the narrowed list of the plurality of identified devices. The process of generating follow-up questions can continue until the specific device is identified.

In some examples the plurality of follow-up questions can include questions based on input received from verbal feedback in real time. As described herein, the term “verbal feedback” refers to feedback received through vocal communication. For example, the system 100 can ask a follow-up question and the first feedback received can be a user vocally responding with a first response to the system 100 in real time. Based on the user's first response, a second follow-up question can be asked in which the user is asked to describe if the specific device is red or white. The user can provide a second feedback by vocally responding with a second response that includes the color to be red.

Instructions 107, when executed by a processing resource such as processing resource 102, can cause system 100 to determine a unique identifier for the specific device from the plurality of different devices based on the description and information received in response to the plurality of follow-up questions. In some examples, feedback received in response to a plurality of the follow-up questions can provide additional information and more accurate description of the specific device. Based on the additional information and the more accurate description, system 100 can determine a unique identifier for the specific device.

For example, the system 100 can utilize identified distinguishable features between a plurality of devices that share common features and generate follow-up questions that may initiate a response to eliminate a portion of the plurality of devices from consideration. As described herein, the system 100 can then generate an updated follow-up questions with the portion of the plurality of devices that are still in consideration to be the specific device. This can be repeated by the system 100 until a relatively small portion or specific device is identified. In these examples, the system 100 can identify the unique identifier or other information associated with the specific device and provide the unique identifier and/or other information to a user.

In some examples, system 100 can update received description and information about the specific device. For example, a received description of the specific device can include a description of a particular feature (e.g. color, etc.) about the specific device from a user's perspective. However, the stored description of the specific device can be different from the description received from the user. In this example, the stored description can be updated to include the description received from the user. In this way, even if the received description varies from one user to another, the specific device is less likely to be removed from consideration while the system 100 is identifying the specific device.

In some examples, the system 100 can determine specific devices from follow-up questions based on an initial description of the specific devices. In some examples, follow-up questions can be provided when a plurality of devices are related to the initial description but are different based on include distinct features they have. The system 100 can generate a narrower list of the devices based on the response to follow-up questions. In some examples, the list of devices can each include features that were described in the received description and/or the response to the follow-up question. Based on that information, a unique identifier or other information associated with the specific device can be provided.

FIG. 2 is an example of a computing device 220 to determine specific devices from follow-up questions consistent with the disclosure. The computing device 220 can include a processing resource 202 communicatively coupled to a memory resource 204 storing instructions 209, 211, 213, 215, and 217 to perform particular functions associated with determining specific devices from follow-up questions. The processing resource 202 and the memory resource 204 can be analogous to processing resource 102 and memory resource 104 described in association with FIG. 1.

Computing device 220 can include instructions 209 stored in the memory resource 204 and executable by the processing resource 202 to identify distinguishable features for a plurality of different devices based on the description of the plurality of features. In some examples, identifying the distinguishable features for the plurality of different devices can be based on the description of the plurality of features stored within a database.

In some examples, the plurality of different devices can include devices that have distinctive physical features. In some examples, the computing device 220 can receive a description of a feature that associates with a specific device. In some examples, the computing device 220 can identify the distinctive features of the described specific device and other devices with the same or similar features. In some examples, follow-up questions can be asked about the predicted specific device. Identifying the distinguishable features can help the computing device 220, using ANN and/or CNN models, to provide more accurate and narrow list that includes the specific device.

In some examples, identifying the distinguishable features can include identifying physical features of the specific device that are different than physical features of the other devices. For example, the computing device 220 can identify that the plurality of features for the specific device and the other devices are distinct based on a description of physical features of the different devices. For example, physical features of the received description of the specific device can include metallic grey case with black logo, and 15-inch screen. Contrarily, physical features of the other devices can include a black case with metallic silver grey logo and 21-inch screen. Based on that determination, computing device 220 can identify a first distinctive feature as the case color (e.g., black vs grey, etc.), a second distinctive feature as a logo color (e.g., black vs silver grey, etc.), and/or a third distinctive feature as a screen size (e.g., 15-inch vs 21-inch, etc.).

In some examples, identifying the description of the plurality of features of the specific device can include detecting a conceptual type association. In some examples, the conceptual type association is made by connecting the description of the plurality of features of the specific device to a plurality of related concepts. In some examples, the conceptual association can be as opposite of literal, association. For example, when a user describes a specific tablet device (e.g., TouchPad) a computer logic can associate the concept of a tablet computer rather than the specific tablet device (e.g., HP Touch Pad).

In some examples, each feature of the plurality of features can be tagged with a reference tag. In some examples, identifying the distinguishable features can include detecting associations between a distinguishable feature of the specific device and the reference tag. For example, a plurality of features of a specific device can be tagged with a reference tag. In some examples, the reference tag can include words, images, and/or other identifying marks assigned to a feature of the specific device. The computing device 220 can identify the features to be same when the reference tag associates with the feature of the specific device and groups them together. In some examples, the computing device 220 can identify the features to be distinguishable when the reference tag does not associate with the feature of the specific device. In some examples, information received from the distinguishable features can be used dynamically update system computing device 220 and improve grouping accuracy of the plurality of features from a corresponding description.

In some examples, computing device 220 can use the ANN model that can use image recognition method to identify images of the different devices by analyzing example images that have been tagged. For example, particular features (e.g., portable, sizes, etc.) of the different devices can be tagged to identify the devices as “portable printing devices”. In some examples, when the features are not tagged, the computing device 220 can use the ANN model to identify the devices as portable printing devices by analyzing the tagged features and matching with the images of the specific features. In some examples, the ANN model can do this without any prior knowledge about the specific device, in this example the portable printing devices. A method learning model, such as an ANN model can automatically generate identifying characteristics from the learning material, for example, initial description received about the plurality of features, that they can process.

Computing device 220 can include instructions 211 stored in the memory resource 204 and executable by the processing resource 202 to provide a plurality of follow-up questions based on the distinguishable features of the plurality of different devices. In some examples, a plurality of follow-up questions can be provided when features of the plurality of devices are identified as distinguishable from each other. For example, if a first feature of a first device is identified to be different from a second feature of a second device, the computing device 220 can provide follow-up questions to further narrow the list of predictable devices.

In this example, the first feature of the first device can be a first material of the enclosure of the first device and the second feature of the second device can be a second material of the enclosure of the second device. In this example, the computing device 220 can generate follow-up questions to identify whether the specific device is made from the first material or the second material. For example, the follow-up question can be “what is the shell of the device made of?”. In this way, a response that the shell of the device is made from the first material can eliminate the second device from consideration and a response that the shell of the device is made from the second material can eliminate the first device from consideration. By eliminating predictable devices from the list, the computing device 220 can lower the quantity of predictable devices that is provided to a user.

Computing device 220 can include instructions 213 stored in the memory resource 204 and executable by the processing resource 202 to determine a unique identifier for the specific device from the plurality of different devices based on the description and information received in response to the follow-up questions. In some examples, the unique identifier can distinguish the specific device from other devices. For example, the unique identifier can be a serial number or a model number that can distinguish the specific device from other similar devices. In some examples, the unique identifier can be utilized to determine additional information for the specific device. For example, the unique identifier can be utilized to troubleshoot technical issues, find parts, determine if upgrades are available, and/or learn about the technical features of the specific device.

Computing device 220 can include instructions 215 stored in the memory resource 204 and executable by the processing resource 202 to determine a received description associated with the unique identifier is different from a stored description of the plurality of features. In some examples, the stored description can include a description received at a time different from a time when the description of the plurality of features of the different devices are received. For example, the stored description can include a description received at a first time period and the description of the plurality of features of the different devices can be received at a second time period. In some examples, the stored description can be a description received at a time prior to the description of the plurality of features of the different devices are received. In some examples, the stored description can be a manufacturer's description of the device. For example, the stored description can be generated by a manufacturer of the device.

In some examples, the description of the specific device can include a description of the color of the specific device from the user's perspective. For example, the description received related to the specific device can include that the color of the specific device is gray. However, the stored description of the specific device can be black. In this example, the description from the user is different than the stored description. In this example, the stored description can be updated to include the description of the specific device as gray or black. In this way, if a different user describes the specific device as gray, the specific device is less likely to be removed from consideration while the computing device 220 is identifying the specific device.

Computing device 220 can include instructions 217 stored in the memory resource 204 and executable by the processing resource 202 to update the stored description of the plurality of features to include the received description of the unique identifier. In some examples, the stored description can be updated in response to determining a discrepancy between a received description of the plurality of features of the specific device during a first time period and a second time period. In some examples, the computing device 220 can determine discrepancy between a stored description and a received description and update the stored description to include the discrepancy. For example, the computing device 220 can receive a feature of the specific device to be pink and determine that the same feature is described as red in the stored description. The computing device 220 can determine the discrepancy between the description of the same feature and update the stored description to include the discrepancy and expand the ways the feature can be identified.

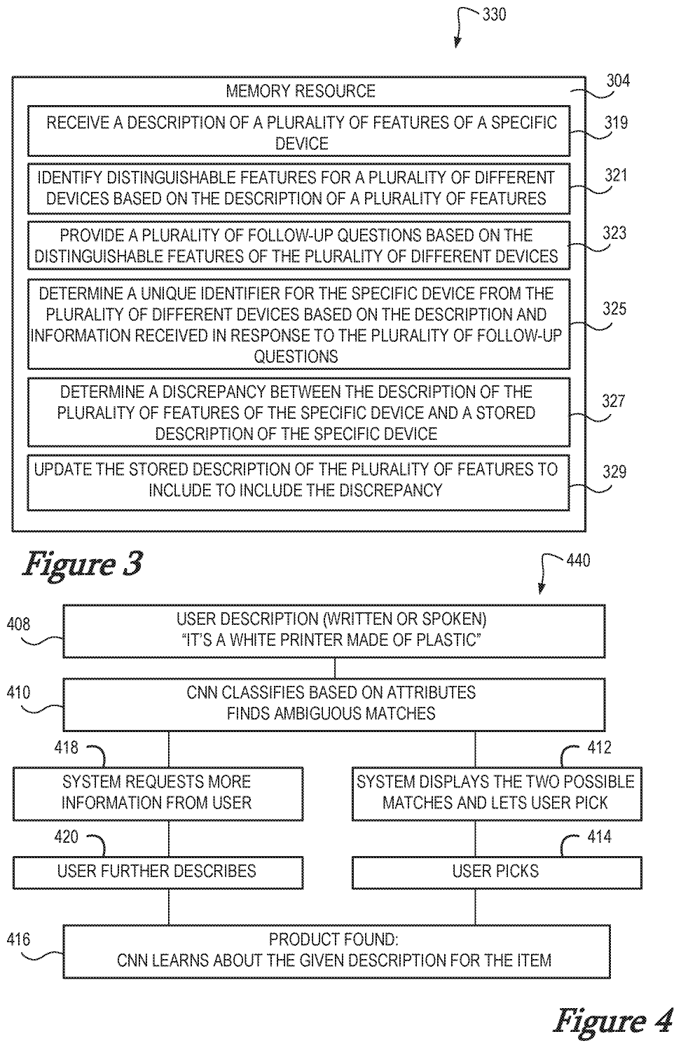

FIG. 3 is an example memory resource 304 to determine specific devices from follow-up questions consistent with the disclosure. In some examples, the memory resource 304 can be a computer-readable storage medium as described herein. In some examples, the memory resource 304 can be communicatively coupled to a computing device (e.g., computing device 220 as referenced in FIG. 2, etc.) and/or other type of physical device that can be utilized to determine specific devices from follow-up questions.

The memory resource 304 can be in communication with a processing resource (e.g., processing resource 102 as referenced in FIG. 1, etc.) via a communication link (e.g., path). The communication link can be local or remote to an electronic device associated with the processing resource. The memory resource 304 includes instructions 319, 321, 323, 325, 327, 329, and 331. The memory resource 304 can include more or fewer instructions than illustrated to perform the various functions described herein, In some examples, instructions (e.g., software, firmware, etc.) 319, 321, 323, 325, 327, 329, and 331 can be downloaded and stored in memory resource 304 (e.g., MRM) as well as a hard-wired program (e.g., logic), among other possibilities.

Instructions 319, when executed by a processing resource, can receive a description of a plurality of features of a specific device. In some examples, the description of the plurality of features of the specific device can include instructions to receive a device type of the specific device. For example, the description of the plurality of features can include “printing device using ink to print images”. Based on the description of the plurality of features, the memory resource 304 can determine that the specific device is an inkjet printer.

In some examples, description of the plurality of features of the specific device can include receiving a geographic location of the specific device. For example, a user can include the geographic location of a printing device (e.g., Minneapolis, Minn., etc.) to describe the printing device. In some examples, the user can utilize a physical location as a feature to describe the specific device. For example, a user can describe a feature of the plurality of features as the color printing devices in a first location. Based on that description, color printing devices of the first location can be collected and narrowed down to a list.

Instructions 321, when executed by a processing resource, can identify distinguishable features between the specific device and a plurality of different devices based on the description of the plurality of features of the specific device. Distinguishable features can include distinctive attributes of the plurality of features that can make different devices distinct from devices that may have overlapping features. For examples, a first printing device and a second printing device can have overlapping features such as the same exterior features such as size, color, etc. However, the finishing process capability (e.g., stapling or whole punching of printing materials, etc.) between the first printer can be distinct from the second printer. The finishing process capability, in this example, be one of the distinguishable features between the two printers.

In some examples, identifying the distinguishable features can include identifying physical features of the specific device that are different than physical features of the other devices. For example, physical features of the received description of the specific device can include a two cartridge color printer. In some examples, physical features of the received description of other devices can include a multi-cartridge color printer. In these examples, the distinguishable feature can be the quantity of cartridges that the specific device utilizes.

In some examples, identifying the description of the plurality of features of the specific device can include detecting a conceptual type association. In some examples, the conceptual type association can identify a generic device even when a specific device is described. For example, when a user describes a specific tablet device (e.g., TouchPad), a computer logic can associate the concept of a tablet computer rather than the specific tablet device (e.g., HP TouchPad). In this way, a list of devices can include more devices with the same generic features, providing a user with options to choose from.

Identifying the distinguishable features can include tagging each feature of the plurality of features with a reference tag. In some examples, a reference tag can include an indicator with information associated with a tagged feature. In some examples, features that were described by a user can be compared to the tagged features of the plurality of devices to determine if the described features are the same or similar to the tagged features. In some examples, the features can be identified as distinguishable when the features described by a user do not associate with the tagged features. In some examples, information received from the distinguishable features can be used to train a system and improve grouping accuracy of the plurality of features. In some examples, information received from the distinguishable features can be used to dynamically update and improve grouping accuracy of the plurality of features from a corresponding description.

Instructions 323, when executed by a processing resource, can provide a plurality of follow-up questions based on the distinguishable features between the specific device and the plurality of different devices. In some examples, a plurality of follow-up questions can be provided when features of the plurality of devices are identified as distinguishable from each other. For example, if a first feature of a first device is identified to be different from a second feature of a second device, the method can generate follow-up questions directed to determine if the specific device is the first device or the second device based on a response to the follow-up questions. In some examples, the follow-up questions can help receive additional information and further narrow the list of identified devices that share the original description of the specific device. For example, method 330 can determine that a first distinguishable feature between the plurality of identified devices is color. In this example, the method 330 can ask a follow-up question about the color of the specific device. In response to the follow-up question, the method 330 can provide a narrow list of the plurality of identified devices and identify a distinguishable feature between the narrowed list of the plurality of identified devices. Again, a follow-up question based on the identified distinguishing feature between the narrowed list of the plurality of identified devices can be asked. The process of generating follow-up questions can continue until the specific device is identified.

Instructions 325, when executed by a processing resource, can determine a unique identifier for the specific device based on the description and information received in response to the plurality of follow-up questions. In some examples, feedback received in response to a plurality of the follow-up questions can provide additional information and more accurate description of the specific device. Based on the additional information and the more accurate description can help determine a unique identifier for the specific device

In some examples, instructions 325, when executed by a processing resource, can provide a selectable display of the plurality of different devices and the specific device. As used herein, the term “selectable display” refers to a display that includes an interface that can be manipulated. In some examples, the selectable display can be manipulated directly on the display (e.g., touchscreen). In some examples, external device (e.g. remote control device, stylus, etc.).

In some examples, based on the received description and information gathered from follow-up questions, a display of the specific devices and other devices and can be displayed. In some examples, the displayed other devices and specific device can have a plurality of features that are similar to each other. For example, based on feedback received from the follow-up questions, if a green tablet device is identified as the specific device, the display can display light green, dark green, teal, and aquamarine tablet devices. In some examples, the displayed other devices and specific device can have plurality of features that distinguishable from each other, as described herein. In some examples, the displayed other devices and specific device can have plurality of features that can be functionally and/or structurally interchangeable.

Based on the display of the different devices, specific and other devices, a selection of the specific devices can be made the selection of the specific device can determine the unique identifier of the specific device. For example, a selectable display can include a first device, a second device, and a third device. Based on the follow-up questions about the first, second and third devices, first device can be selected as the specific desired device. In Some examples, selection of the first device can help determine the unique identifier of the specific device. In some examples, the unique identifier can be a numerical value, an alpha-numeric value.

Instructions 327, when executed by a processing resource, can determine a discrepancy between the description of the plurality of features of the specific device and a stored description of the specific device. In some examples, the stored description can include a description received at a time different from a time when the description of the plurality of features of the different devices are received. For example, the stored description can include a description (e.g., manufactured by a first manufacturer) received at a first time period and the description (e.g., manufactured by a second manufacturer) of the plurality of features of the different devices can be received at a second time period.

Instructions 329, when executed by a processing resource, can update the stored description of the plurality of features to include the discrepancy. In some examples, the stored description can be updated in response to determining a discrepancy between a received description of the plurality of features of the specific device during a first time period and a second time period. For example, the description of a received feature of the specific device can to be pink. In some examples, it can be determined that the same feature is described as red in the stored description. In some examples, the discrepancy between the description of the same feature can be updated to include the discrepancy and expand the ways the feature can be identified.

FIG. 4 is a flow diagram of system 440 of user interaction to determine specific devices from follow-up questions consistent with the disclosure. System 440 can be utilized to determine a specific device from follow-up questions.

At 408 system 440 can include instructions to receive description of a specific device that the user intends to lookup. In some examples, description of the plurality of features can be received via written texts. In some examples, description of the plurality of features can be received via speech and converted to text. In some examples, description of the plurality of features can be received from physical gesture received from a user.

In some examples, the user may not know the exact name of the specific device. In such examples, the user can describe the specific device by describing a plurality of the features of the specific device. For example, the user can describe the specific device as: “the device is a white printer, made of plastic”.

At 410, the system 440 can include instructions to, using deep learning model (e.g., CNN, ANN), classify and cluster features of the plurality of features. In some examples, the system 440 can identify distinguishable features for the plurality of different devices based on the description of the plurality of features. For example, the system can identify that a first product is a white printer and made of plastic, and the second printer is also a white printer made of plastic. In some examples, a database (not shown in FIG. 4) is trained to cluster features based on their common attributes. In some examples, a CNN and/or ANN model can initially learn about the devices and their generic descriptions. Based on that, the devices can be clustered when a user is trying to look up a specific device using the genetic description. In some examples, the distinguishable features of the devices that are grouped together for some common attributes are determined.

At 418, system 440 can include instructions to provide follow-up questions. For example, if a first feature of a first device is identified to be different from a second feature of a second device, and the first device is identified as a tablet computer, the system 440 can provide follow-up questions aimed towards tablet computer to further narrow down the list of the tablet computers.

In some examples, the system 440 can provide additional follow-up questions to further narrow down the list of specific devices. In some examples, based on the responses received, the system 440 can identify a first, a second and third tablet computers as the narrow list of desired tablet computers

At 412, system 440 can include instructions to display the first device and the second device as the specific device. In some examples, the first device can be the exact specific device the user is looking for. In some examples, the second device can be similar to the specific device with features the user may not have been aware of. The display of both the first and the second device can allow the user to select the specific device. This can be helpful if the user is not aware of specific devices with improved features.

At 414, system 440 can include instructions for the user to select the specific device the user is looking for. In Some examples, selection of the specific device can help determine the unique identifier of the specific device. In some examples, a received description associated with the unique identifier is different from a stored description of the plurality of features. In some examples, the stored description can include a description received at a time different from a time when the description of the plurality of features of the different devices are received.

At 416, system 440 can to update the stored description of the plurality of features to include the received description of the unique identifier. In some examples, the stored description can be updated in response to determining a discrepancy between a received description of the plurality of features of the specific device during a first time period and a second time period. For example, the CNN and/or ANN model can learn features of the specific device to be pink and determine that the same feature is described as red in the stored description and update the stored description to include the discrepancy and expand the ways the feature can be identified.

Since many examples can be made without departing from the spirit and scope of the system and method of the disclosure, this specification merely sets forth some of the many possible example configurations and implementations. In the disclosure, reference is made to the accompanying drawings that form a part hereof, and in which is shown by way of illustration how a number of examples of the disclosure can be practiced. These examples are described in sufficient detail to enable those of ordinary skill in the art to practice the examples of this disclosure, and it is to be understood that other examples can be used and that process, electrical, and/or structural changes can be made without departing from the scope of the disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the disclosure. In addition, the proportion and the relative scale of the elements provided in the figures are intended to illustrate the examples of the disclosure, and should not be taken in a limiting sense.

What is claimed is:

1. A system comprising:
a processing resource; and
a memory resource storing machine readable instructions to cause the processing resource to:
receive a description of a plurality of features of a specific device;
identify distinguishable features for a plurality of different devices based on the description of the plurality of features, wherein the plurality of different devices includes the specific device and other devices with the plurality of features;
provide a plurality of follow-up questions based on the distinguishable features of the plurality of different devices; and
determine a unique identifier for the specific device from the plurality of different devices based on the description and information received in response to the plurality of follow-up questions.

2. The system of claim 1, wherein the instructions to identify the distinguishable features for the plurality of different devices comprise instructions to:
tag each feature of the plurality of features with a reference tag; and
detect associations between a distinguishable feature of the specific device and the reference tag.

3. The system of claim 1, wherein the instructions to identify the distinguishable features include instructions to identify physical features of the specific device that are different than physical features of the plurality of other devices.

4. The system of claim 1, wherein the instructions to receive the description of the plurality of features of the specific device include instructions to receive a geographic location of the specific device.

5. The system of claim 4, wherein the geographic location of the plurality of different devices is used to distinguish between the specific device and other devices with the plurality of features.

6. The system of claim 1, wherein the instructions to receive the description of the plurality of features of the specific device include instructions to receive a device type of the specific device.

7. The system of claim 1, wherein the instructions to provide the plurality of follow-up questions include questions based on input received from verbal feedback, selection feedback, textual information, and pictorial display updated in real time.

8. A computing device comprising:
a processing resource; and
a memory resource storing machine readable instructions to cause the processing resource to:
identify distinguishable features for a plurality of different devices based on a description of a plurality of features of a specific device, wherein the plurality of different devices includes the specific device and other devices with the plurality of features;
provide a plurality of follow-up questions based on the distinguishable features of the plurality of different devices;
determine a unique identifier for the specific device from the plurality of different devices based on the description and information received in response to the follow-up questions;
determine a received description associated with the unique identifier is different from a stored description of the plurality of features; and
update the stored description of the plurality of features to include the received description of the unique identifier.

9. The computing device of claim 8, wherein the instructions to identify the distinguishable features for the plurality of different devices comprises instructions to detect a conceptual type association by connecting the description of the plurality of features of the specific device to a plurality of related concepts.

10. The computing device of claim 8, wherein the instructions to determine the unique identifier comprises instructions to generate an output based on a received query that includes the description and information received in response to the follow-up questions.

11. The computing device of claim 8, wherein the stored description includes a description received at a time different from a time when the description of the plurality of features of the different devices are received.

12. The computing device of claim 8, wherein the stored description is updated in response to determining a discrepancy between a received description of the plurality of features of the specific device during a first time period and a second time period.

13. A non-transitory computer readable medium storing instructions executable by a processing resource to cause the processing resource to:
receive a description of a plurality of features of a specific device;
identify distinguishable features between the specific device and a plurality of different devices based on the description of the plurality of features of the specific device;
provide a plurality of follow-up questions based on the distinguishable features between the specific device and the plurality of different devices;
determine a unique identifier for the specific device based on the description and information received in response to the plurality of follow-up questions;
determine a discrepancy between the description of the plurality of features of the specific device and a stored description of the specific device; and
update the stored description of the plurality of features to include the discrepancy.

14. The medium of claim 13, comprising instructions to:
provide a selectable display of the plurality of other devices and the specific device;
receive a selection of the specific device; and
determine the unique identifier based on the selection of the specific device.

15. The medium of claim 14, wherein the selectable display includes the distinguishable features between the specific device and the other devices of the plurality of different devices.
